(19) United States
(12) Patent Application Publication
(10) Pub. No.: US 2025/0117412 A1
(43) Pub. Date: Apr. 10, 2025

(54) ISOLATING PASSAGES FROM CONTEXT-LADEN COLLABORATION SYSTEM CONTENT OBJECTS

(71) Applicant: Box, Inc., Redwood City, CA (US)

(72) Inventors: Sesh JALAGAM, Union City, CA (US); Denis GRENADER, Dover, NH (US); Benjamin John KUS, Alameda, CA (US)

(73) Assignee: Box, Inc., Redwood City, CA (US)

(21) Appl. No.: 18/731,086

(22) Filed: May 31, 2024

Related U.S. Application Data
(60) Provisional application No. 63/543,503, filed on Oct. 10, 2023.

(51) Int. Cl. G06F 16/332; G06F 16/335; G06F 16/383

(52) U.S. Cl. CPC G06F 16/3329; G06F 16/335; G06F 16/383

(57) ABSTRACT

Methods, systems, and computer program products for collaboration systems. A method for identifying selected portions of a set of content objects for use in generating a large language model (LLM) prompt comprises: identifying a content management system (CMS) wherein collaboration activities occur over time and over content objects maintained in the CMS, and wherein the CMS maintains a historical record of occurrences of the collaborator activities over the content objects. Upon receiving a natural language query from a CMS collaborator, reducing a larger corpus of content objects to a smaller corpus of context passages that are used in an LLM prompt. The smaller corpus of passages is formed using a two-phase reduction scheme whereby firstly, selected constituents from the larger corpus of content objects are identified based on CMS metadata; and then, rather than considering the larger corpus, instead considering only the selected constituents when generating the LLM prompt.

### RELATED APPLICATIONS

The present application claims the benefit of priority to co-pending U.S. Provisional Patent Application Ser. No. 63/543,503 titled “METHOD AND SYSTEM TO IMPLEMENT ARTIFICIAL INTELLIGENCE INTEGRATED WITH A CONTENT MANAGEMENT SYSTEM” filed on Oct. 10, 2023, which is hereby incorporated by reference in its entirety.

### TECHNICAL FIELD

This disclosure relates to collaboration systems, and more particularly to techniques for isolating passages from context-laden collaboration system content objects.

### BACKGROUND

The emergence of generative artificial intelligence (GAI) has advanced how computer users interact with the massive amalgamation of online corpora comprising virtually all material that is posted online. Now, users can pose questions to a GAI entity and the GAI entity can return what are to be presumed to be answers to the posed questions. While such a question/answer interaction might be useful in certain situations, returning answers that are based on the whole of the foregoing amalgamation of online corpora comprising virtually all material that is posted online, the answers to the posed questions, while quite possibly correct and on point, might be far more generalized that what the user is trying to find out.

Consider the question, “What is the latest happening in the first congressional district of Idaho?” and then consider the answer, “The general election for Idaho's 1st Congressional District is scheduled for Nov. 5, 2024, with the primary having taken place on May 21, 2024.” However, the user might have wanted an answer that was more related to that user's activities and interests. For example, and referring again to the question, “What is the latest happening in the first congressional district of Idaho?” given a GAI entity that is trained on a corpus of documents that are related to the user, the GAI entity might have responded, “You made a $1000 contribution to Rep. Russ Fulcher's campaign on May 1, 2024.” As one can see, the answer, “You made a $1000 contribution to Rep. Russ Fulcher's campaign on May 1, 2024” is far more relevant to the user than the former answer, “The general election for Idaho's 1st Congressional District is scheduled for Nov. 5, 2024.” What emerges from this observation is that the more context that the GAI entity has as pertains to the particular user, the more likely the GAI is able to engage in a question/answer session that is relevant to that particular user.

Unfortunately, the current state of GAI technologies places limits on the amount of context that can be provided to a GAI entity. As such, even if there is user-specific context available, due to the aforementioned limit, that user-specific context might not be able to be presented to the GAI entity in as full a measure as might be needed to assist the GAI entity in producing user-relevant answers. What is needed are ways to interact with a GAI entity in a manner that produces user-relevant answers in spite of limitations placed on how much information can be provided to the GAI entity as context. The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for isolating passages from context-laden collaboration system content objects, which techniques advance the relevant technologies to address technological issues with legacy approaches. Certain embodiments are directed to technological solutions for distilling from millions of collaboration files down to only a small set of passages from context-laden collaboration system content objects.

The disclosed embodiments modify and improve beyond legacy approaches. In particular, the herein-disclosed techniques provide technical solutions that address the technical problems attendant to limits on the amount of context that can be ingested as a large language model prompt. Such technical solutions involve specific implementations (e.g., data organization, data communication paths, module-to-module interrelationships, etc.) that relate to the software arts for improving computer functionality.

The ordered combination of steps of the embodiments serve in the context of practical applications that perform steps for distilling from millions of collaboration files down to only a small set of passages from context-laden collaboration system content objects. As such, techniques for distilling from millions of collaboration files down to only a small set of passages from context-laden collaboration system content objects overcome long-standing yet heretofore unsolved technological problems associated with severe limits on the amount of context that can be ingested as a large language model (LLM) prompt that arise in the realm of computer systems.

Many of the herein-disclosed embodiments for distilling from millions of collaboration files down to only a small set of passages from context-laden collaboration system content objects are technological solutions pertaining to technological problems that arise in the hardware and software arts that underlie enterprise-scale collaboration systems. Aspects of the present disclosure achieve performance and other improvements in peripheral technical fields including, but not limited to, human-machine interfaces and LLM interfaces.

Some embodiments include a sequence of instructions that are stored on a non-transitory computer readable medium. Such a sequence of instructions, when stored in memory and executed by one or more processors, causes the one or more processors to perform a set of acts for distilling from millions of collaboration files down to only a small set of passages from context-laden collaboration system content objects.

Some embodiments include the aforementioned sequence of instructions that are stored in a memory, which memory is interfaced to one or more processors such that the one or more processors can execute the sequence of instructions to cause the one or more processors to implement acts for distilling from millions of collaboration files down to only a small set of passages from context-laden collaboration system content objects.

In various embodiments, any combinations of any of the above can be organized to perform any variation of acts for isolating passages from context-laden collaboration system content objects, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A1 depicts an example failure scenario that occurs when passages taken from context-laden collaboration system content objects and provided as a prompt to a large language model overflows a prompt size limit.

FIG. 1A2 depicts an example success scenario that occurs when passages taken from context-laden collaboration system content objects and provided as a prompt to a large language model are limited to observe a large language model prompt size limit.

FIG. 1B is a system-level block diagram showing an example system implementation wherein content is ranked for relevance to a particular collaborator prior to producing a prompt to a large language model, according to an embodiment.

FIG. 1C is a block diagram of an example relevant passage determination system that limits the amount of context-laden collaboration system content that is a candidate to be provided as a prompt to a large language model, according to an embodiment.

FIG. 2 is a block diagram of a system showing an example end-to-end flow that limits the amount of context-laden collaboration system content that is a candidate to be provided as a prompt to a large language model, according to an embodiment.

FIG. 3 depicts an example group assignment technique that relies on metadata values pertaining to collaboration system content, according to an embodiment.

FIG. 4 depicts an example relevant chunk extraction technique that identifies selected passages from context-laden collaboration system content, according to an embodiment.

FIG. 5 depicts an example relevant chunk scoring technique that scores passages that have been extracted from context-laden collaboration system content, according to an embodiment.

FIG. 6 depicts an example large language model prompt generator that limits the size of a prompt by considering only the top high-scoring chunks for presentation in an LLM prompt, according to an embodiment.

FIG. 7A, FIG. 7B and FIG. 7C present block diagrams of computing architectures having components suitable for implementing embodiments of the present disclosure and/or for use in the herein-described environments.

### DETAILED DESCRIPTION

Aspects of the present disclosure solve problems associated with using computer systems that enforce limits on the amount of context that can be ingested as a large language model prompt. These problems are unique to, and may have been created by, various computer-implemented methods that underly the amount of context that can be ingested as a large language model prompt. Some embodiments are directed to approaches for distilling from millions of collaboration files down to only a small set of passages from context-laden collaboration system content objects, which are in turn used to generate a prompt to a large language model (LLM). The accompanying figures and discussions herein present example environments, systems, methods, and computer program products for isolating passages from context-laden collaboration system content objects.

### Overview

As indicated in the BACKGROUND section of this disclosure, the current state of GAI technologies places limits on the amount of context that can be provided to a GAI entity. So, while it might be possible to provide a significant amount of user-specific context, due to the aforementioned limits, such a significant amount of user-specific context might not be able to be presented to the GAI entity.

A situation where there indeed exists such a significant amount of user-specific context might exist emerges by virtue of the vast amount of current and historical information available within the confines of an enterprise-class collaboration system. That is, a collaboration system that is implemented as a set of computer-implemented modules that interoperate to capture, store, and provision access to a historical record of nearly all collaborator activities is intrinsically configured to be able to provide a user-specific history of access/sharing events taken over shared files or other content objects. As such, the inner workings of the collaboration system have the internal knowledge to know what files or other content objects are relevant to a particular user. This is because, since the user-specific history of access/sharing events taken over shared files or other content objects is stored in a manner for subsequent retrieval, the collaboration system can implement timewise and user-wise tracking of collaboration events.

This timewise and user-wise tracking of collaboration activities and other events is sometimes called a “user journey.” The foregoing collaboration activity tracking notwithstanding, it is possible to track myriad events of the CMS, possibly including any time-stamp-able events such as content object uploads, file accesses, collaboration group changes, even including time-oriented user interaction behaviors such as click rates and mouse hover time. Such activity tracking can be stored as a nonvolatile history of events that in aggregate comprise a historical record of occurrences of collaborator activities, which events can be accessed going back in time to some earliest moment of tracking (e.g., the first event from a new user, the first event over an initially-present or uploaded content object).

Further details regarding general approaches to forming a nonvolatile history of activity events and means to access said historical activities are described in U.S. application Ser. No. 16/154,679 titled “ON-DEMAND COLLABORATION USER INTERFACES” filed on Oct. 8, 2018, which is hereby incorporated by reference in its entirety.

Since the collaboration system retains a timewise and user-wise tracking of collaboration events during the course of a “user journey,” the collaboration system can identify files or folders or workflows or metadata or other content objects that are putatively (a) highly relevant to the specific user posing the question to the GAI, and (b) highly relevant to what that specific user is doing within the collaboration system.

Now, given the foregoing, and for sake of further explaining this example, consider the situation where a subject collaborator had composed a letter to his/her congressperson, wherein the content of the letter provides details of his/her campaign contribution. As such, then the example question, “What is the latest happening in the first congressional district of Idaho?” the answer, “You made a $1000 contribution to Rep. Russ Fulcher's campaign on May 1, 2024” is not only highly relevant to the particular user making the inquiry to the GAI entity (e.g., the subject collaborator), it is also highly relevant to what that particular user (e.g., the subject collaborator) had been doing in a recent timeframe. And noting in this example that the response, “You made a $1000 contribution to Rep. Russ Fulcher's campaign on May 1, 2024” might indeed be the very latest “[ . . . ] happening in the first congressional district of Idaho.”

The foregoing example seems to imply that the collaboration system is able to understand the semantics of both (a) the question, as well as (b) the content of the letter to his/her congressperson. This degree of semantic understanding might or might not be available in a given collaboration system. In fact, rather than being able to simply “leap” to a relevant document (i.e., in this case, the user's letter to his/her congressperson), a collaboration system might have to consider many files, sometime thousands of files or more in order to stumble upon relevant files and then isolate relevant passages of the files. It can sometimes happen that a GAI entity can isolate relevant passages of the files, however this brings one back to the fact of the highly undesirable limit of how much context can be provided to a GAI entity.

Furthermore, this brings one to consider one of the complexities to be addressed by this disclosure. Specifically, given a question or possibly a series of interrelated questions to be posed to a GAI entity, how can a collaboration system distill the context down from thousands of files or sometimes millions of files to merely a few thousand words that are probabilistically deemed to contain one or more answers sought by the user. Various techniques to distill context-laden content objects down from thousands of files or sometimes millions of files and/or millions of passages to merely a few thousand words that can then be used in a prompt to a GAI entity that supports a large language model (LLM) are presented hereunder and in the appended figures.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

Many of the embodiments discussed herein are, or are situated in, an enterprise-class collaboration system. As used herein, a “collaboration system” is a collection of executable code that facilitates sharing content objects and establishing a set of users who can access the shared content objects concurrently. In some embodiments as contemplated herein, a “collaboration system” is implemented as a set of computer-implemented modules that interoperate to capture, store, and provision access to electronically-stored data (e.g., a historical record of collaborator activities) that is associated with a history of access/sharing events taken over shared content objects by two or more collaborators. Access by users to individual ones of the content objects of a content management system (CMS) is controlled by collaboration group settings. A series of collaboration events for a particular collaborator is sometimes called “timewise tracking of collaboration events,” and “timewise tracking of collaboration events” is sometimes called a “user journey.”

As used herein, a collaboration group refers to any set of identifiers pertaining to users of a content management system. Such identifiers may include usernames, email aliases, user device identification information, etc. A collaboration group can be associated with any number of attributes and attribute values, and such attributes and attribute values can be inherited by members of a particular collaboration group. The constituency of a collaboration group serves to aid in cooperative activities over collaboration system documents and metadata.

As used herein, a “content object” is any computer-readable, electronically-stored data that is made accessible to a plurality of users of a collaboration system. Different collaboration system users may each have respective permissions to access the electronically-stored data. The electronically-stored data may be structured as a file, or as a folder/directory, or as metadata, or as a combination of the foregoing. The electronically-stored data might be or might not be human intelligible. Moreover, it can happen that some parts of a content object are human intelligible, while other parts of the same content object are not human intelligible. This can happen, for example, when a content object is composed of a mixture of Unicode character data as well as binary data.

As used herein, “content object deep inspection” refers to analysis of human-readable intelligence by considering the meaning of human-readable words within a collaboration object.

As used herein, the term “collaboration activities” refers to actions that involve two or more users who access the same content object of a collaboration system in the same time period. Strictly as examples, the term “collaboration activities” may refers to any one or more of (1) activities undertaken while participating in a multi-user real-time document editing, etc. session, and/or (2) activities undertaken when executing a workflow, and/or (3) activities undertaken while participating in a web conference, etc. Strictly as further examples, collaboration activities can include modification of a collaboration group, or an occurrence of an upload event, or an occurrence of a preview event, or an occurrence of a workload access event, etc.

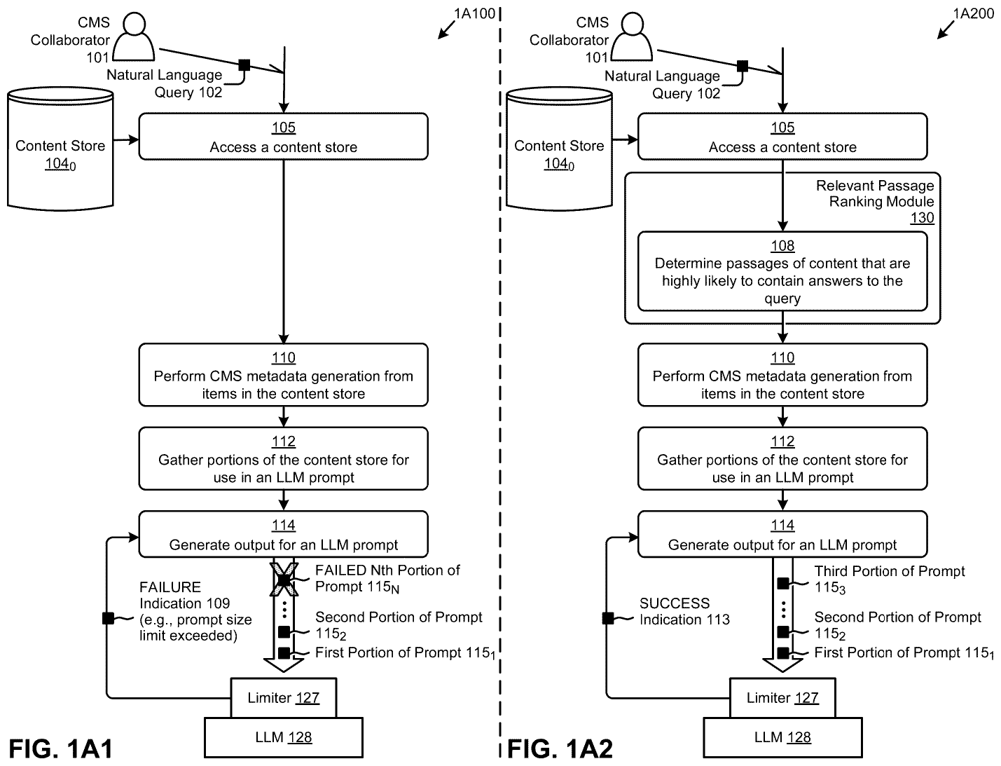

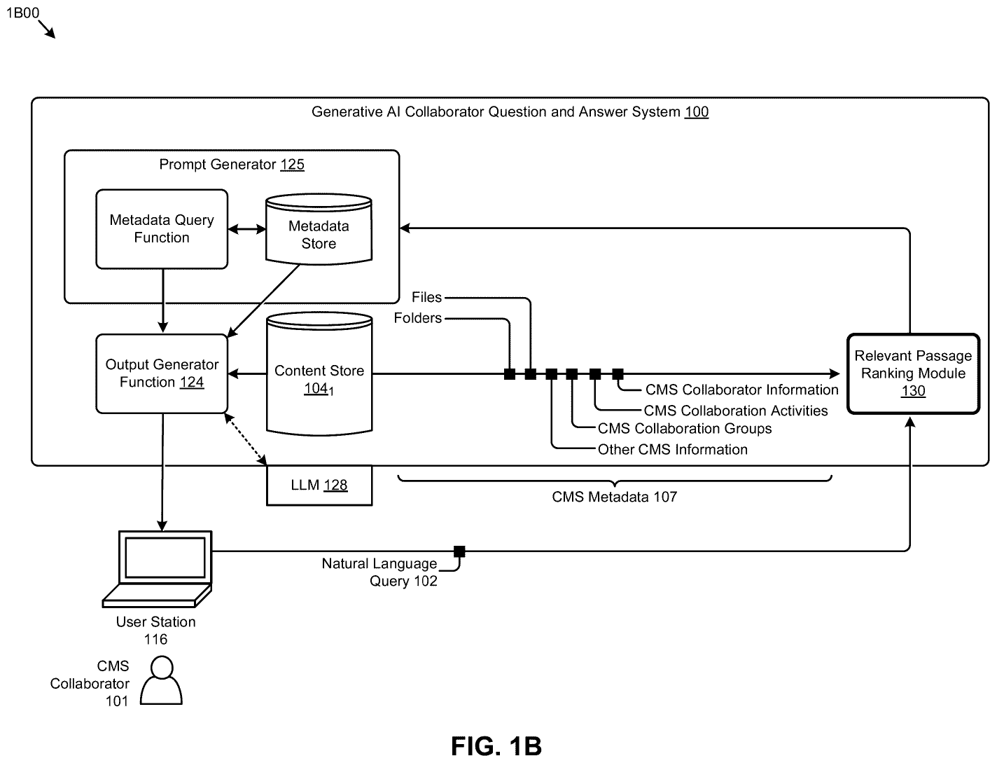

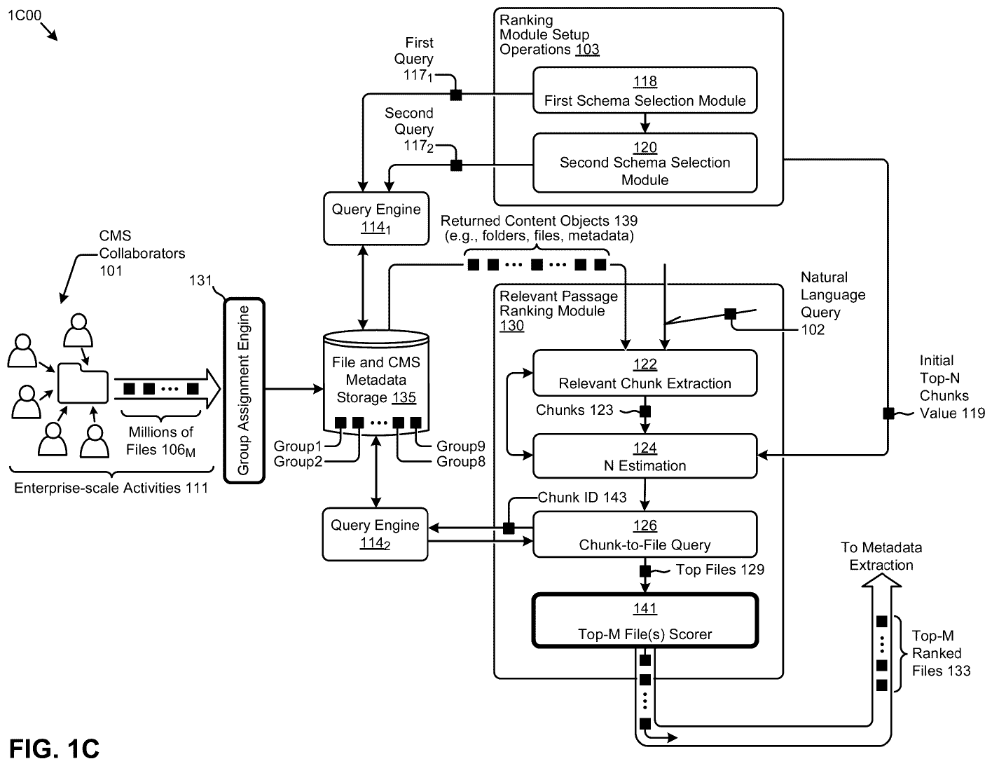

FIG. 1A1 depicts an example failure scenario that occurs when passages taken from context-laden collaboration system content objects and provided as a prompt to a large language model overflows a prompt size limit. In absence of the technological advances presented herein many variations of failure scenario 1A100 may occur in the context of the architecture and functionality of the embodiments described herein and/or in any environment.

The figure is being presented to illustrate that, in the absence of the technological advances presented herein, failure scenario 1A100 may occur in nearly every prompt to an LLM. This is because even using the most advanced LLMs, the limiter 127 will restrict the size of an LLM prompt to a size that is only a minuscule fraction of the amount of context that could be provided to an LLM.

In this scenario, and as shown, the flow commences when a user (e.g., the shown CMS collaborator 101) raises a question (e.g., natural language query 102) to be answered by an LLM. Strictly as one example, such a question could be something like, “What is the ‘execution date’ of this contract?” As can be understood by those of ordinary skill in the art, a contract might have many provisions in which the defined term ‘execution date’ is present, yet without actually having an answer to what the execution date is. Naively walking through the contract from top to bottom and pulling out all of the provisions that have the string “execution date” would merely fill up the prompt buffer beyond the LLM's limit, yet without ever producing any passage or passages that include the execution date. This creates an untenable situation for enterprise-class collaboration systems where such questions are frequently raised.

So, to explain the details of what happens in this scenario, start with a consideration that at step 105, an enterprise-class collaboration system storage facility (e.g., content store 104₀) is accessed. Unfortunately, in an enterprise-class collaboration system the content store grows into a larger and larger corpus of content objects and CMS metadata. There is a need to process the huge corpus of content objects and CMS metadata to a much smaller corpus of context passages that are used in generating an LLM prompt that does not exceed the LLM's limit. This can be done through a processes of ingestion. In this embodiment, one or more computer-implemented modules are configured to ingest passages and or content object metadata, and convert the passages or content object metadata into bits that are saved into the content store. Such saving into the content store might be performed a priori, even before any specific schema pertaining to sought-after context is considered (e.g., in response to a content object upload event), and/or such saving CMS metadata into the content store might be performed at a later point in time once one or more specific schema pertaining to sought-after metadata is considered.

A modern and well featured enterprise-class collaboration system further performs CMS metadata generation from items in the content store (step 110), after which step 112 serves to gather portions of the content store for use in an LLM prompt. Next, an LLM prompt is generated (e.g., step 114), and the prompt is then provided to a large language model (e.g., LLM 128). Unfortunately, even the largest of modern large language models enforce a limit as to the size of the prompt (e.g., the number of tokens in the prompt). This is because large language models rely on a finite depth of parameters, possibly organized as parameterized neurons in a neural net.

As shown, when a constructed LLM prompt (e.g., comprising a first portion of prompt 115₁, a second portion of prompt 115₂, . . . , and FAILED Nth portion of prompt 115_{N}) is input into the LLM, a limiter (e.g., limiter 127) emits an error (e.g., FAILURE indication 109), thus resulting in a failure or degradation of the ability to use the LLM to answer the question. This strongly unwanted scenario can be ameliorated by observing the limitations of the LLM prompt ingestion, and then by providing information in the prompt that is deemed to be highly likely to include the answer to the question.

FIG. 1A2 depicts an example success scenario that occurs when passages taken from context-laden collaboration system content objects and provided as a prompt to a large language model are limited to observe a large language model prompt size limit. As an option, one or more variations of success scenario 1A200 or any aspect thereof may be implemented in the context of the architecture and functionality of the embodiments described herein and/or in any environment.

This figure is being presented to illustrate the differences between the foregoing failure scenario of FIG. 1A1 and the success scenario of FIG. 1A2. Specifically, when comparing FIG. 1A1 to FIG. 1A2, it can be seen that FIG. 1A2 includes a relevant passage ranking module 130, which module is not present in the legacy example of FIG. 1A1. Operation of such a relevant passage ranking module 130 results in determination of which passages of content are indeed highly likely to contain answers to the question (e.g., step 108 of relevant passage ranking module 130), while not providing content in the prompt that is not highly likely to contain answers to the question. As such, and referring to the foregoing example when addressing the question “What is the ‘execution date’ of this contract?”, an implementation of the techniques herein would almost certainly include the portion of the contract that actually has the answer, while limiting the number or size of paragraphs that might refer to the “execution date” but do not provide the answer. This is shown by the stream of portions of the constructed prompt (e.g., comprising a first portion of prompt 115₁, a second portion of prompt 115₂, and a third portion of prompt 115₃), and by the SUCCESS indication 113.

This is a significant technological advance and is an advance that can be implemented in a system that generates limited size prompts when using an LLM to answer a CMS collaborator's question.

FIG. 1B is a system-level block diagram showing an example system implementation wherein content is ranked for relevance to a particular collaborator prior to producing a prompt to a large language model. As an option, one or more variations of system-level block diagram 1B00 or any aspect thereof may be implemented in the context of the architecture and functionality of the embodiments described herein and/or in any environment.

The figure is being presented to illustrate one possible juxtaposition of a relevant passage ranking module 130 within a larger implementation of a generative AI collaborator question and answer system 100. More particularly, system-level block diagram 1B00 shows that the foregoing relevant passage ranking module 130 can use CMS metadata 107 to greatly reduce the amount of candidate context drawn from an enterprise-class collaboration system, even before the candidate context is further processed to reduce the extent of passages that might be used into an LLM prompt. One of skill in the art will recognize that reducing from (potentially) millions of files down to (potentially) a much smaller number of files that are deemed to be relevant to a collaboration user's inquiry is a first step to accomplish even before processing the contents of the reduced set of files to identify relevant passages.

In this example system, CMS collaborator 101 interacts at user station 116. As an output of such interaction, the user station emits the shown natural language query 102. Natural language query 102 in turn is ingested by relevant passage ranking module 130 in a manner such that only relevant content, that is, content relevant to the particular natural language query, is considered when generating a prompt. This is shown by the juxtaposition of relevant passage ranking module 130 as being between content store 104₁ and downstream processing.

As can now be understood by inspection of system-level block diagram 1B00, output generator function 124 can be configured to receive outputs of prompt generator 125 and, in turn, use that prompt when interacting with LLM 128. Furthermore, and as shown, output generator function 124 can present results, possibly involving an answer from the LLM, to the CMS collaborator based on some graphical user interface situated at user station 116.

The foregoing discussion of FIG. 1B pertains merely to some possible embodiments and/or ways to implement a generative AI collaborator question and answer system 100. Many variations are possible; for example, a generative AI collaborator question and answer system, or more particularly, relevant passage determination as comprehended in the foregoing can be implemented in any environment, one example of which is shown and described as pertains to the FIG. 1C.

FIG. 1C is a block diagram of an example relevant passage determination system that limits the amount of context-laden collaboration system content that is a candidate to be provided as a prompt to a large language model. As an option, one or more variations of content management system 1C00 or any constituent relevant passage determination system or any aspect thereof may be implemented in the context of the architecture and functionality of the embodiments described herein and/or in any environment.

The figure is being presented to illustrate how, in spite of the scale of an enterprise-class collaboration system, and in spite of the presence of literally millions of files 106_{M}, and in spite of the potential for many millions of enterprise scale activities 111, a relevant passage ranking module can nevertheless reduce such millions of files to only a miniscule set of files that contain relevant chunks.

The reader's attention is drawn to group assignment engine 131. It is in this group assignment engine that the potential millions of files can be reduced down to a small fraction of those millions of files, where each of the files in that small fraction correspond to a subject CMS collaborator and/or to other CMS collaborators. In enterprise class situations a particular CMS collaborator might collaborate with many different other CMS collaborators in many different groups. For example, a CMS collaborator in engineering might collaborate with another person in marketing. Or, a CMS collaborator in marketing might interact with a CMS collaborator in the legal department. As shown, various files and or its containing folder(s) and/or it's metadata can be tagged with group assignments. In this depiction, the file and CMS metadata storage 135 includes content objects that are in turn tagged with group identifications such as, group1, group2, group8, group9, etc. Such groups might be derived from a collection of user profiles, or such groups can be or can be derived from collaboration groups in which a particular CMS collaborator is a member.

In some cases, group designations might be determined in response to a content object upload event or other event arising from ingestion. In some cases, group designation determinations and/or tagging of content objects with group designations might be performed at a later point in time (e.g., long after initial ingestion) once one or more specific characteristics of the content object (e.g., presence of personally identifiable information, a security clearance or restriction, etc.) are determined. In some cases, determinations of one or more specific characteristics of the content object might cause collaboration group modifications and/or might initiate further collaboration group modification actions.

As is known to those of skill in the art, collaboration groups can be defined by an administrator (e.g., by placing all employees of a particular department or subsidiary into a particular collaboration group), or automatically, based on clustering or other processing over events in the CMS.

Further details regarding general approaches to forming collaboration groups are described in U.S. application Ser. No. 16/051,447 titled “SPONTANEOUS NETWORKING” filed on Jul. 31, 2018, which is hereby incorporated by reference in its entirety.

Now, to understand the semantics underlying this group assignment, and moreover to understand the extreme efficacy of this technique, one need only observe that an answer to a CMS collaborator's question—if it is to be relevant to that CMS collaborator—would almost necessarily relate to the particular CMS collaborator that raised the question, who that particular CMS collaborator is (e.g., based on a user profile), and/or what that particular CMS collaborator has been doing. Therefore, when performing ranking module setup operations 103, it becomes felicitous to construct a first query 117₁ (and present to query engine 114₁) that includes a first set of selection criteria that is derived from some schema (e.g., as in step 118) that pertains to the CMS collaborator that raised the natural language query.

Furthermore, when performing ranking module setup operations 103, it also becomes felicitous to identify a second schema (e.g., as in step 120), which is in turn used to construct a second query 117₂ (and present to query engine 114₁) that includes a second set of selection criteria that pertains to what the user is doing, or has been doing, and/or with whom that user is or has been interacting. This technique then reduces down to a relatively small set of returned content objects 139 that at least satisfy the foregoing first and/or second selection criteria, which in turn pertain specifically to this CMS collaborator and this CMS collaborator's activities.

As a consequence of having this already reduced set of returned content objects, it is possible to do relevant chunk extraction over this reduced set of returned content objects. Again, one need only observe that an answer to a CMS collaborator's question—if it is to be relevant to that CMS collaborator—would almost necessarily relate to one or more of (1) the particular CMS collaborator that raised the question, (2) the user profile of that particular CMS collaborator, (3) what that particular CMS collaborator has been doing, and (4) some timeframe that is relevant to the semantics of the natural language query.

Given the foregoing set of returned content objects 139 and a (possibly preprocessed) natural language query 102, the shown relevant chunk extraction 122 can commence. Extraction of chunks 123 can be greedy in the sense that some of the chunks can be later discarded if they do not fall within the cardinality of the so called top-N chunks (e.g., the cardinality of the top-N chunks value 119). A top-N chunks value can be determined relative to some initial top-N chunks value 119, which may be set by default, or may be set (initially) based on outputs from the ranking module setup operations 103. The size or cardinality of the top-N chunks as a whole can be bounded by a number N.

Now, in some embodiments and/or in some situations (e.g., based on the semantics of natural language query 102), there may be a reverse lookup carried out by the shown chunk-to-file query 126 (possibly through query engine 114₂) such that files or folders or other containers is/are retrieved based on the occurrence and identification of a highly-ranked chunk (e.g., shown as chunk ID 143). Such a reverse lookup might return a set of containers (e.g., the shown top files 129) which may then be ranked to generate some ordinal regime over the top files 129. In this embodiment, if there is a relatively large number of top files (e.g., the shown top files 129), that relatively large number of top files might be reduced to a smaller set of top-M ranked files 133, wherein the size of the smaller set is bounded by a number M. This can be accomplished by a ranker/scorer (e.g., top-M files scorer 141), which is capable of outputting the set of top-M ranked files 133. Such a set of top-M ranked files 133 are made available for further processing.

The foregoing discussion of FIG. 1C pertains to merely some possible embodiments and/or ways to implement a relevant passage determination system. Many variations are possible; for example, the relevant passage determination system as comprehended in the foregoing can be implemented in any environment or as a portion of a series of steps.

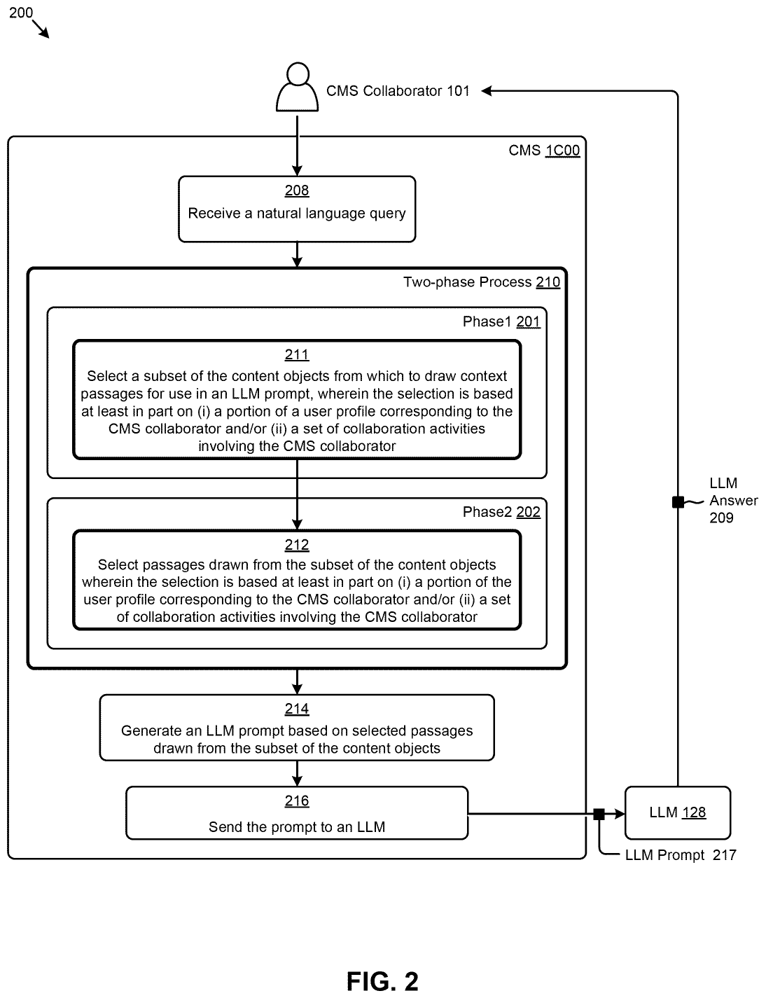

FIG. 2 is a block diagram of a system showing an example end-to-end flow that limits the amount of context-laden collaboration system content that is a candidate to be provided as a prompt to a large language model. As an option, one or more variations of system 200 or any aspect thereof may be implemented in the context of the architecture and functionality of the embodiments described herein and/or in any environment.

The figure is being presented to illustrate how a two-phase process 210 can be used in an end-to-end flow. Specifically, the figure is being presented to illustrate how a two-phase process can be carried out in response to receiving a natural language prompt (step 208). Specifically, and as shown, the two-phase process is carried out by (1) selecting a subset of content objects that are deemed to be pertinent to answering a natural language query (in step 211 of phase1 201), and then (2) selecting specific passages that are deemed to be pertinent to answering the same natural language query (in step 212 of phase2 202). The figure is also being presented to show how generation (at step 214) of an LLM prompt 217 and provision (at step 216) of such an LLM prompt for/to an LLM 128 can be used in an end-to-end flow that results in an LLM answer 209 to a natural language query.

In some embodiments, the output of the first phase may come as a stream of content objects (or content object identifiers) that are consumed by operational elements of the second phase. In this configuration processing of the first phase can run concurrently with processing of the second phase. In some such embodiments, phase1 and phase2 form a processing pipeline.

Although this embodiment includes consideration of CMS metadata in both phases, it is sometimes sufficient to reduce the full corpus of content objects of the CMS down to a subset of content objects that are deemed to be pertinent to answering a natural language query—even though it is entirely possible that the entirety of each of the subset of content objects might be deemed to be pertinent to answering said natural language query. As such, the entirety of each of the subset of content objects might be used when generating an LLM prompt. In fact, in some CMS deployments, all or most of the content objects are very small, possibly constituted by only a single sentence or phrase or passage. In such cases, the entirety of each of the subset of content objects might be deemed to be pertinent context, which is then used to generate an LLM prompt.

### Computer-Implemented Modules

As an option, system 200 may be composed of computer-implemented modules that operate in the context of the architecture and functionality of the embodiments described herein. Of course, however, system 200 or any operation therein may be carried out in any desired environment. The shown system comprises a plurality of modules, a module comprising at least one processor and a memory, and any module can communicate with other modules over a network communication link. The modules of the system can, individually or in combination, or serially or in parallel, perform method steps (e.g., step 211, step 212, step 214, step 216). Any method steps (or portions thereof) performed within system 200 may be performed in any order unless as may be specified in the claims.

As shown, system 200 implements a method for isolating context-laden passages from content objects of a collaboration system by first selecting a subset of the content objects from which to draw context passages for use in an LLM prompt (step 211), and then, selecting certain passages drawn from the subset of the content objects wherein the selecting is based at least in part on (i) a second portion of the user profile corresponding to the CMS collaborator, and/or (ii) a second set of collaboration activities involving the CMS collaborator.

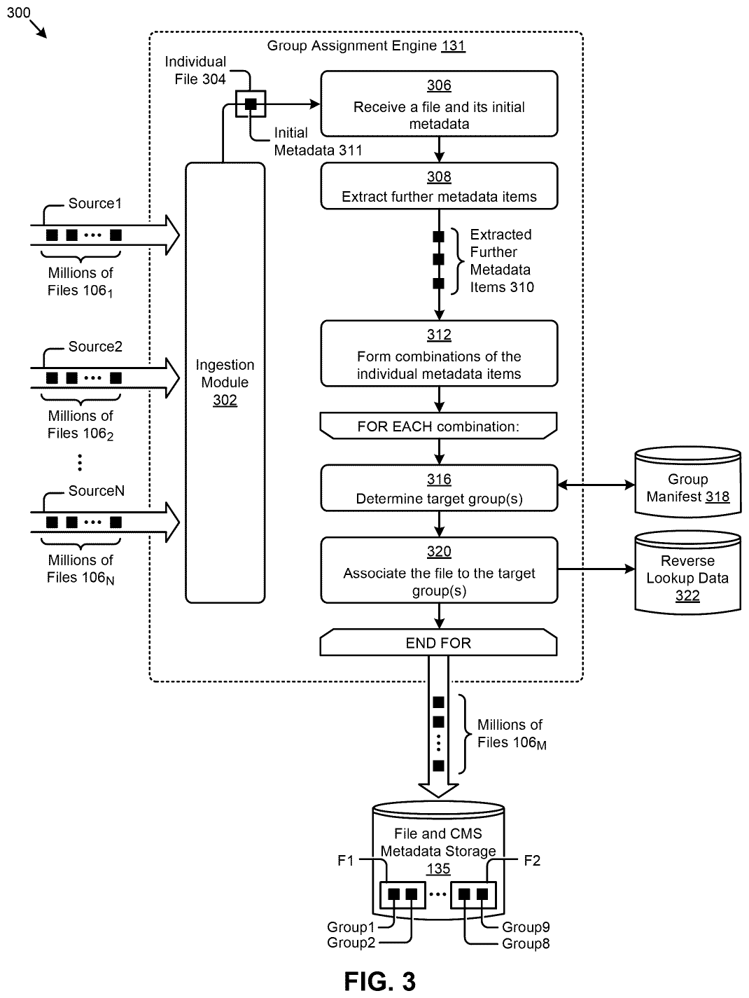

The foregoing discussion of FIG. 2 pertains to merely some possible embodiments and/or ways to implement a relevant passage determination system. Many variations are possible; for example, the relevant passage determination system as comprehended in the foregoing can be implemented in any environment. In particular, the determination of which content objects are relevant content objects might be made based at least in part on group assignments that are derived from metadata of the CMS. One possible technique for assigning groups is shown and described as pertains to FIG. 3.

FIG. 3 depicts an example group assignment technique that relies on metadata values pertaining to collaboration system content. As an option, one or more variations of group assignment technique 300 or any aspect thereof may be implemented in the context of the architecture and functionality of the embodiments described herein and/or in any environment.

The figure is being presented to illustrate how information of a content management system (e.g., CMS metadata) can be used to group content objects (e.g., files or folders or other CMS data items) so as to segregate certain content objects from other content objects. This technique serves to provide a filter that can be applied across (possibly) millions of files. As depicted in the figure, there may be many reasons why a content object would be included in one or more particular groupings. Strictly as examples, a content object might be assigned into a collaboration group (e.g., either under administrative control, or automatically based on CMS activities or events), or a content object might be assigned into a target group based on extracted metadata.

As shown, group assignment engine 131 ingests (e.g., via ingestion module 302) content objects from many sources (e.g., source1, source2, . . . , sourceN), which, over time, such sources may upload many millions of files (e.g., millions of files 106₁, millions of files 106₂, . . . , millions of files 106_{N}). Any particular individual file (e.g., file 304) may include initial tagging or other information (e.g., initial metadata 311). The ingestion module or another operation (e.g., operation 306) can receive the content object (e.g., file 304, as shown) and process it in a manner that extracts further metadata from the contents of the file (e.g., via operation 308).

Such further metadata might include, strictly as examples, personally identifiable information (PII), relationships of the file or its uploader to any one or more CMS collaborators, and/or references to other content objects, etc. As such, a stream of extracted further metadata items 310 can be provided to a permuter/combiner (e.g., exemplified by operation 312), and such a permuter/combiner or any operation thereto can formulate and/or determine target groups. Such determined or formulated groupings (e.g., based on permutations and/or combinations therefrom) can be processed individually in a FOR EACH loop (e.g., by operation 316) where each permutation or combination is individually considered to determine one or more target groups. The determined target groups can be retrieved from and/or stored in a group manifest 318.

To further explain, a particular target group might be defined based on some combination of inherent, implied or extracted information, or tracked information (e.g., tracked activities). For example, a particular instance of file 304 might have initial metadata 311 that indicates that the file is (or is intended to become) a publicly-accessible document. That same a particular instance of file 304 might be determined (e.g., in operation 308) that there is PII in the content portion of the file. In such a case, the combination might cause further metadata to be extracted (e.g., the location or nature of the PII). Furthermore, the combination might cause the file to be tagged with a target group designation that corresponds to a sensitivity designation.

As another example of combining information at the time of ingestion so as to classify an uploaded document into one or more groups, consider the case of uploading a content object that is a contract. The mere fact that the ingest module can know that the uploaded document is a contract opens up a panoply of possibilities to relate the document to other relevant documents, and possibly classify the uploaded contract into a target group. Continuing the instant example of uploading a document that is a contract, the total contract value (TCV) can be extracted and combined with other information of the CMS in order to calculate a “liability cap” (e.g., a formula involving the TCV), which calculated liability cap can in turn can be used with still other information of the CMS (e.g., a liability cap threshold) to classify the document into a “risk pool” which is captured and maintained by the CMS as corresponding to a particular type of target group designation. Still continuing this example, and to illustrate that an incoming file can be classified into a group based on the then current activities over content objects in the CMS, consider that when a contract document is uploaded, the ingest module can check for activity over documents in the target folder. If there is activity in related documents (e.g., in or over an envelope for an e-signing process, or in or over a sales order form in the same folder, etc.) then the incoming document might be classified into a target group that carries the semantic of “Soon Closing” deals.

Target group designations such as mentioned above, and/or any other type of group designation, can be used during practice of the techniques or methods described herein. As detailed in the foregoing example, an incoming file might be deemed (e.g., via operation 308) to be a contract. Further, again as detailed in the foregoing example, any information that is extracted from an incoming file (e.g., a TCV) can then be associated (e.g., via operation 320) with the file using any known-in-the-art technique. Those of skill in the art will recognize how name-value pairs or key-value pairs (e.g., {TCV, $1M) or {riskPool=“Yes”}) can be used to relate the file to an extracted and/or computed value that in turn serves to relate the file to one or more target groups and/or other semantics.

In some embodiments, a reverse lookup facility is provided (e.g., using reverse lookup data 322) by, in addition to relating a file to a target group, the reverse lookup facility relates a target group to a file or files (e.g., file F1 and file F2). Processing though the operations of group assignment engine 131 may result in file and CMS metadata storage 135 being populated with files (e.g., file F1 and file F2), each or many of which have associations to one or more groups (e.g., file F1 is associated with group1 and group2 and file F2 is associated with group8 and group9).

Referring back to FIG. 1C, and specifically referring to the shown file and CMS metadata storage 135, it is now clear that the relevant passage ranking module 130 can avail of these groupings-to-file or file-to-groupings assignments in a manner that can, at least in part, inform whether or not a particular file is thought to be relevant to an incoming natural language query as raised by a CMS user.

The foregoing discussion of FIG. 3 pertains to merely some possible embodiments and/or ways to implement a group assignment technique. Many variations are possible; for example, the group assignment technique as comprehended in the foregoing can be implemented in any environment and/or in any process and/or for any purpose. More specifically, the foregoing group assignment technique can be used in processes involved in chunk identification and extraction from context-laden collaboration system content.

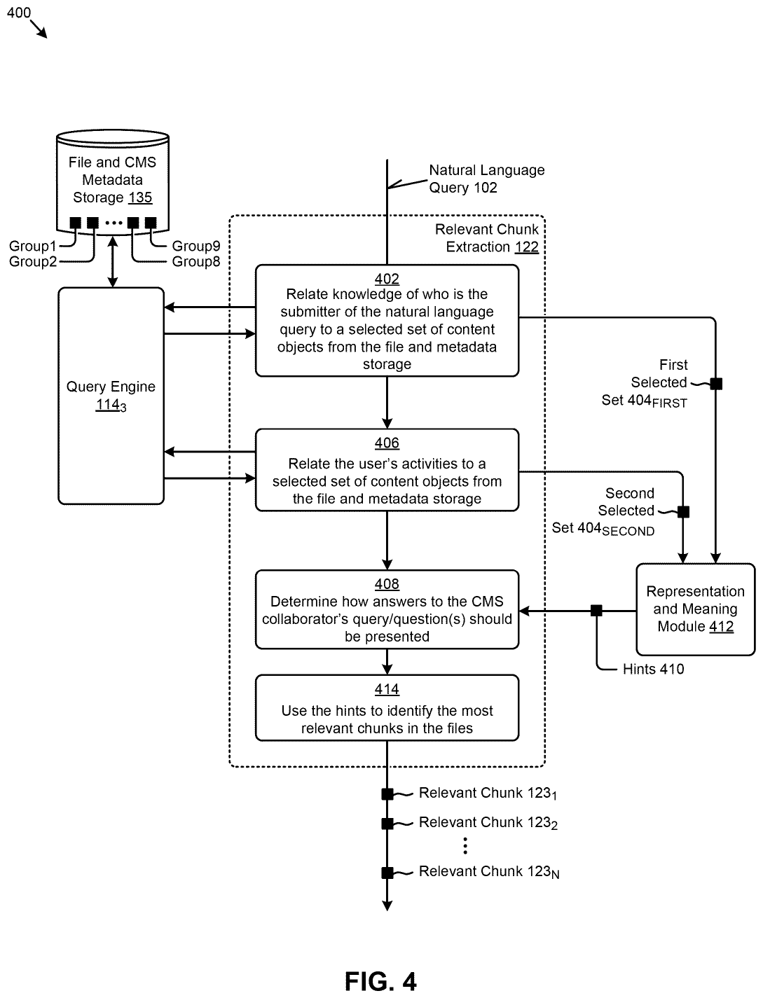

FIG. 4 depicts an example relevant chunk extraction technique that identifies selected passages from context-laden collaboration system content. As an option, one or more variations of relevant chunk extraction technique 400 or any aspect thereof may be implemented in the context of the architecture and functionality of the embodiments described herein and/or in any environment.

The figure is being presented to illustrate how a relevant chunk extraction technique can be applied in the context of a CMS. More specifically, the figure is being presented to expound on how relevant chunk extraction can be configured to selectively consider only certain files or other content objects from file and CMS metadata storage, even though relevant chunk extraction technique 400 may need to draw from an extremely large corpus of CMS content objects and/or an extremely large corpus composed of file and CMS metadata storage 135. In this particular embodiment, the relevant chunk extraction technique is able to leverage (1) who is the CMS collaborator who is posing the natural language query, and (2) what that CMS collaborator has been doing. Having knowledge of who the CMS collaborator is facilitates querying (e.g., using the shown query engine 114₃). Using knowledge of who the CMS collaborator is, means that even when accessing an extremely large corpus of file and CMS metadata storage, processing over that large corpus can be configured to select only content objects that are likely to relate to the inherent interests of the CMS user who posed the natural language query. Then, furthermore, having the knowledge of what the inquiring CMS collaborator has been doing facilitates querying the extremely large corpus of file and CMS metadata storage to select only content objects that are likely to relate to expressed interests of the posed natural language query.

One need only observe that a CMS collaborator explicitly expresses interest in some (often relatively very small) fraction of the large corpus by virtue of what collaboration activities that CMS collaborator has undertaken in a timeframe of relevance. Accordingly, using knowledge of who the CMS collaborator is, and what that CMS collaborator has been doing, means that it is possible to relate at least some semantics expressed or inherent in the natural language query to a mere fraction of the content objects of the CMS corpus of content objects.

In the example embodiment shown in FIG. 4, it is possible to relate knowledge of who is the submitter of the natural language query to a selected set of content objects (e.g., the shown first selected set 404_{FIRST}) by asking the query engine to return only selected files from the vast corpus of files, possibly based on groupings (step 402).

Furthermore, in the example embodiment shown in FIG. 4, it is possible to relate knowledge of what the submitter of the natural language query is doing to a selected set of content objects (e.g., the shown second selected set 404_{SECOND}) by asking the query engine to return only selected files from the vast corpus of files, possibly based on the CMS collaborator's content object access patterns (step 406). This is possible, at least when there exists a history of collaboration activity tracking information that relates the user's activities to selected ones of content objects. For example, it is a reasonable assumption that if a CMS collaborator created and uploaded a file to the CMS, then that CMS collaborator has an interest in the uploaded file. Similarly, if a first CMS collaborator previewed and/or modified a file created by a second (different) CMS collaborator, then the first CMS collaborator can be assumed to have an interest in the previewed and/or modified file.

This FIG. 4, in addition to showing and explaining how a set of files can be selected based on who the CMS collaborator is and what they are doing, also shows and describes how relevant chunk extraction can consider the representation and meaning of the submitted natural language query. Specifically, step 408 serves to determine how answers to the CMS collaborator's query/question(s) should be presented. This determination can be based on a particular specification by the submitter (e.g., “Give me a table having rows with the missing signatories for all contracts that have a total contract value over $100,000”) or, a determination can be made based on inherency or implications that emerge from representation and meaning of content within the selected set of files. For example, if the selected files repeatedly discuss a “directed acyclic graph” and the query requests a “graph”, then it can be inferred (e.g., via the shown representation and meaning module 412) that the CMS collaborator is requesting a graph in the specific form of a “directed acyclic graph.” As such, hints 410 might include “graph” and “directed acyclic graph,” and those hints can then be used to identify the most relevant chunks that pertain to the form or format of the answer (step 414).

In this manner (i.e., as shown and described here in this FIG. 4) a stream of relevant chunks (e.g., relevant chunk 123₁, relevant chunk 123₂, . . . , relevant chunk 123_{N}) can be output for downstream processing. In some cases, it turns out that the number of, and aggregate size of, the relevant chunks of the stream might far exceed the limits placed on the prompt size enforced by the LLM. In such cases, downstream processing might rank relevancy of individual ones of the stream and thereby reduce the number and/or size of the chunks. In some cases, downstream processing may influence relevancy thresholds used in relevant chunk extraction 122. For example, if downstream processing deems that more relevant chunks are needed, the downstream processing can provide feedback to the relevant chunk extraction operations so as to request, either explicitly or in an implied sense, that the relevant chunk extraction operations still need more chunks to consider.

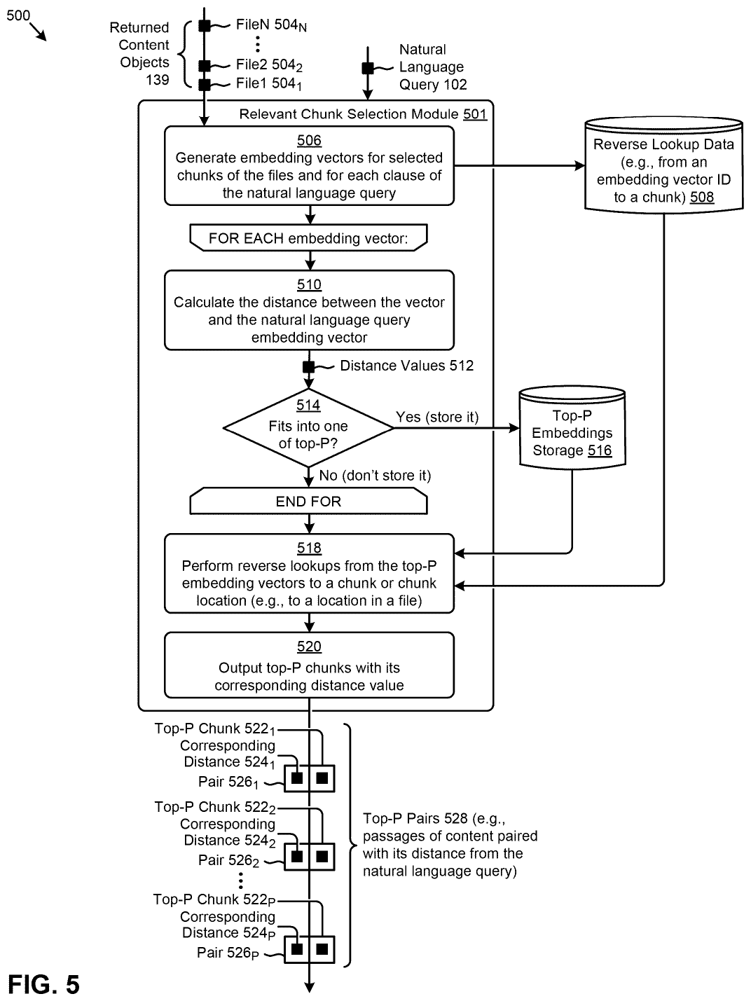

The foregoing discussion of FIG. 4 pertains to merely some possible embodiments and/or ways to implement a relevant chunk extraction technique. Many variations are possible; for example, the relevant chunk extraction technique as comprehended in the foregoing can be implemented using any of a variety of downstream scoring techniques, one particular technique of which is shown and described as pertains to FIG. 5.

FIG. 5 depicts an example relevant chunk scoring technique that scores passages (e.g., relevant chunks) that have been extracted from context-laden collaboration system content. As an option, one or more variations of relevant chunk scoring technique 500 or any aspect thereof may be implemented in the context of the architecture of the shown relevant chunk selection module 501 and/or in any environment.

Although there are many ways to scores passages that have been extracted from context-laden collaboration system content (e.g., using a high-dimensional vector database, using approximate nearest neighbor (ANN) algorithms, using retrieval-augmented generation (RAG), etc.), this FIG. 5 is being presented to illustrate how various relevant chunk scoring techniques (e.g., ANN and/or RAG) might be configured to operate in an environment that scores passages of content objects (e.g., file1 504₁, file2 504₂, . . . , fileN 504_{N}) against an incoming natural language query 102. More particularly, the figure is being presented to illustrate how a RAG-based chunk scoring technique might be configured to score embeddings of passages of content objects against embeddings of an incoming natural language query.

To explain, high-dimension vector databases are often used to implement RAG as a method to improve domain-specific responses of large language models. The retrieval component of a RAG can be any search system, however, for purposes of explaining the embodiment of FIG. 5, the search system considered here includes a queryable vector database. In operation, text passages of documents that at least potentially describe a domain of interest are gathered, then for each passage, a feature vector known as an embedding is computed and then stored in a vector database. Next, given a natural language query, the feature vector for that natural language query is computed and the vector database is queried to retrieve the most relevant passages. These most relevant passages are then considered for inclusion into the context window of the large language model. The large language model can then, given the context of the most relevant passages—which is statistically most likely to be relevant to the CMS collaborator's natural language query—proceeds to create a response (e.g., an answer) to the CMS collaborator's natural language query prompt (e.g., a question).

Any known form or release or distro for ANN or RAG may be used. However, there are certain configurations and/or advances in the state of the art of feature vector comparison technologies that are particularly suited for addressing situations where there are multiple query clauses or multiple questions in a CMS collaborator's natural language query.

Continuing the discussion of how relevant chunk selection is carried out, those skilled in the art will recognize the technique for generating embedding vectors (step 506) for passages or chunks so as to perform downstream processing to find out which passages or chunks are most likely to contain answers to a user-posed question. As shown, in a FOR EACH loop, each of the embedding vectors for the passages or chunks are compared to the vector(s) for the natural language query, thusly calculating a distance metric (step 510). Only a fraction of the embeddings (e.g., the top-P embeddings) are further considered for use in an LLM prompt. This is accomplished by calculating the distance between each chunk vector and the natural language embedding vector (step 510), and then maintaining only the P of those vectors that have the highest seen distance values 512 (i.e., the top-P chunks). The processing for maintaining only the P of those vectors (e.g., corresponding to the top-P chunks) can be done at decision 514 as well as pursuant to taking the “Yes” branch of decision 514, which in turn results in a store operation into Top-P embeddings storage 516. The stored top-P embeddings and/or information pertaining to the top-P embeddings (e.g., the identity of a chunk or location corresponding to the embedding, the number ‘P’, a distance metric value, etc.) can be retrieved from top-P embeddings storage 516 during later processing (as shown). The size or cardinality of the top-P embeddings can be bounded by a number P.

The value of the number P can be determined a priori, or the value of P can be determined dynamically, possibly based on some calculation involving the combination of the size of considered chunk size(s), the size of the natural language query, and/or a maximum size of the prompt for a particular LLM.

Still continuing the discussion of how to accomplish relevant chunk selection, after distances for all of the chunk vectors compared to the natural language embedding vector have been calculated and segregated into just a top-P subset of embedding vectors, then a reverse lookup is performed (step 508) so as to be able to output just the top-P chunks with corresponding characterization (step 518). In some embodiments, the top-P chunks with corresponding characterization are output (at step 520) as pairs (e.g., pair 526₁, pair 526₂, . . . , pair 526_{P}), where each pair includes a particular top-P chunk (e.g., top-P chunk 522₁, top-P chunk 522₂, . . . , top-P chunk 522_{P}) as well as its distance value (e.g., corresponding distance 524₁, corresponding distance 524₂, . . . , corresponding distance 524_{P}). As such, the top-P pairs 528 can be passed on to downstream processing (e.g., to operations for prompt generation).

At least inasmuch as generative AI systems are sensitive to the order of words that occur in a prompt, it is important to observe the original ordering of passages as may have appeared in a particular document. To further explain by example, given a set of documents D1, D2 where chunk C1 and C2 are selected from document D1, and where chunks C3 and C4 are selected from document D2, the chunk order as found in a given document can be deemed to be observed so long as there is no interleaving between document chunks. As such, a natural ordering that observes the original ordering of passages in a document might be “D1C1, D1C2, D2C3, D2C4”. An alternative ordering might be “D2C3, D2C4, D1C1, D1C2” (noting that the chunks from within a given document are presented in the order in which they appear in their containing document). However, any reordering of chunks that vary from the order in which they appear in their containing document would be avoided. Furthermore, interleaving of chunks from different documents should be avoided. Consider a reordering such as “D1C1, D2C3, D1C2”; in this case, even though, strictly speaking, C2 follows C1 (which is the order in which they appear in their containing document), chunk C3 (from a different containing document) is deleteriously interleaved between C1 and C2.

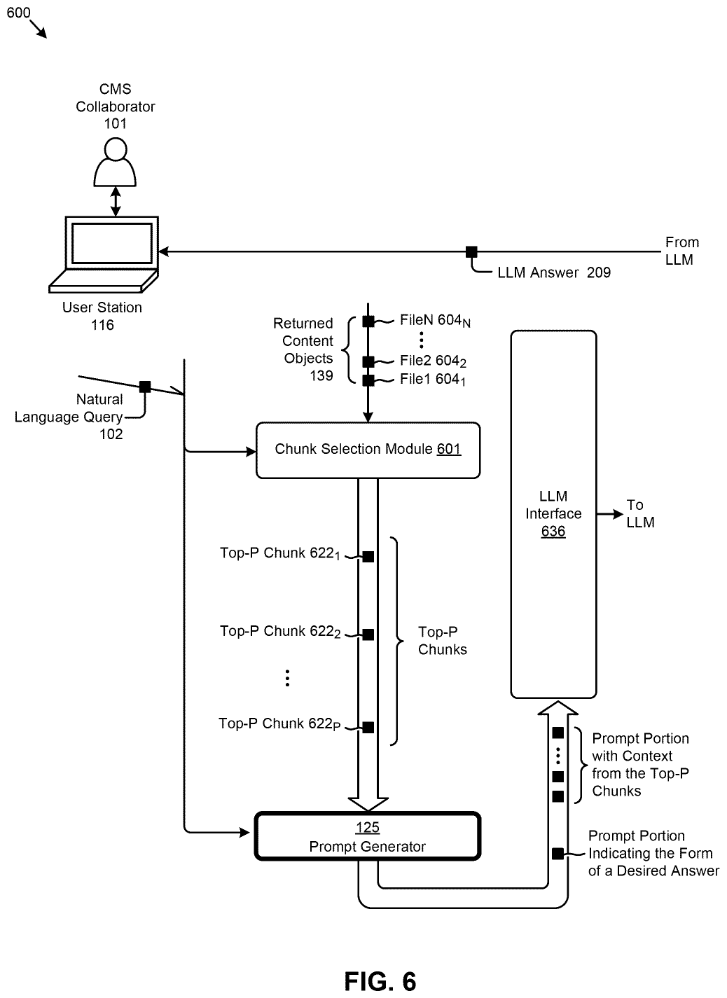

The foregoing discussion of FIG. 5 pertains to merely some possible embodiments and/or ways to implement relevant chunk scoring and ordering. The scored chunks can be arranged into a prompt, possibly with the CMS collaborator's natural language query being included in the prompt, which prompt is then provided to an LLM. This latter case is shown and described as pertains to FIG. 6.

FIG. 6 depicts an example large language model prompt generator that limits the size of a prompt by considering only the top high-scoring chunks for presentation in an LLM prompt. As an option, one or more variations of large language model prompt generation technique 600 or any aspect thereof may be implemented in the context of the architecture and functionality of the embodiments described herein and/or in any environment.

As shown, chunk selection module 601 provides inputs to prompt generator 125. The prompt generator is interfaced with LLM interface 636, which in turn is interfaced with the LLM itself in a manner that the LLM can return (either directly or indirectly) LLM answer 209 to the CMS collaborator's user station 116. One characteristic of this embodiment is that the prompt generator is provided with a limited set of chunks (e.g., top-P chunk 622₁, top-P chunk 622₂, . . . , top-P chunk 622_{P}) derived from a limited set of files (e.g., file1 604₁, file2 604₂, . . . , fileN 604_{N}). Specifically, the prompt generator is provided with only those chunks that have been selected based on scoring, which scoring in turn considers the limitations of a particular large language model.

To more fully understand, consider an implementation where a particular chunk selection module is configured to reduce the number or quantity of chunks to be considered such as has been described in the foregoing. In such an implementation, the prompt generator can apply its full set of features over input that is already known to have been vetted for usefulness in answering a posed question. This creates somewhat of a best-of-all-possible-worlds situation, and one that is a boon to content management systems.

The foregoing discussion of FIG. 6 pertains to merely some possible embodiments and/or ways to implement a large language model prompt generation technique. Many variations are possible; for example, the large language model prompt generation technique as comprehended in the foregoing can be implemented in any environment and/or in the context of any type of computer system comporting to any architecture, one example of which is shown and described as pertains to the following figures.

### System Architecture Overview

### Additional System Architecture Examples

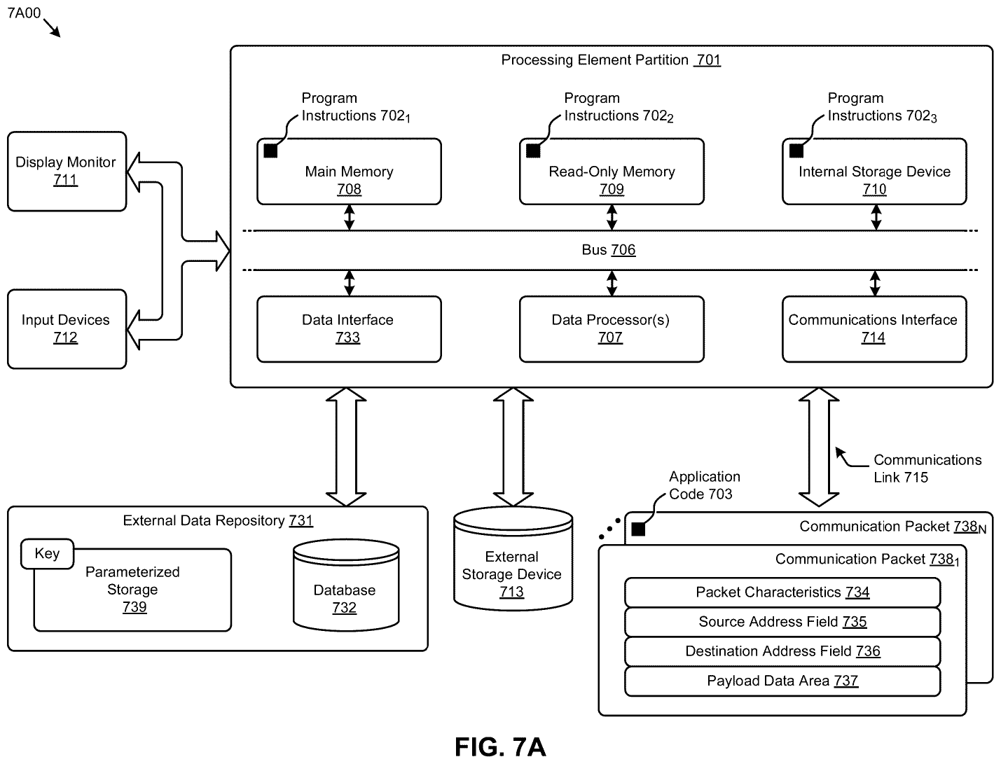

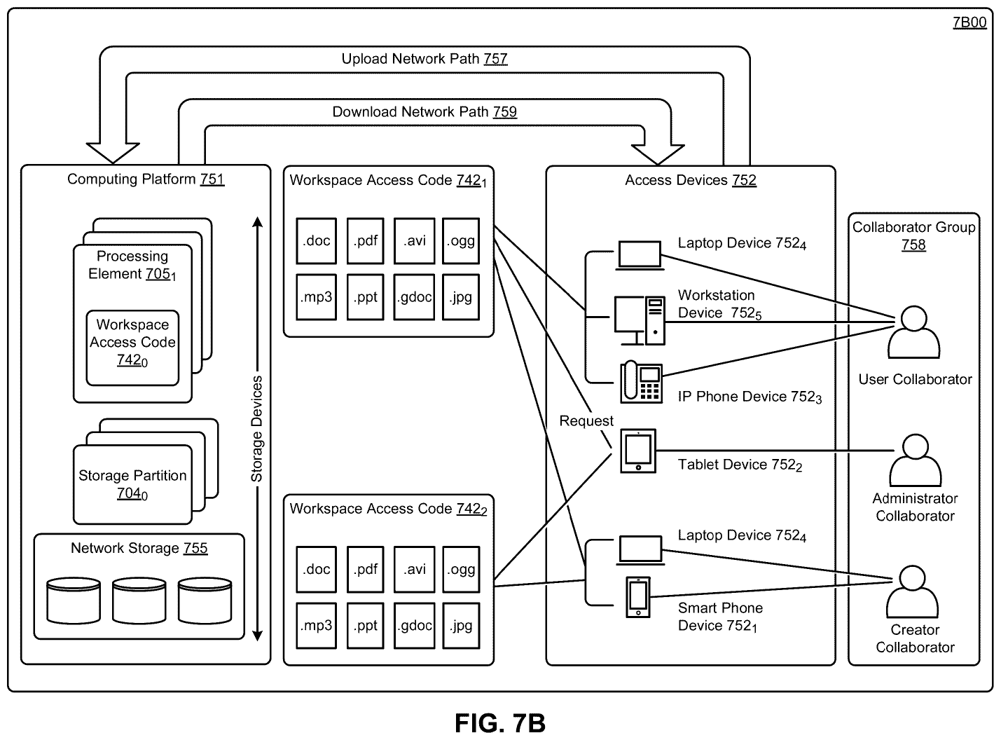

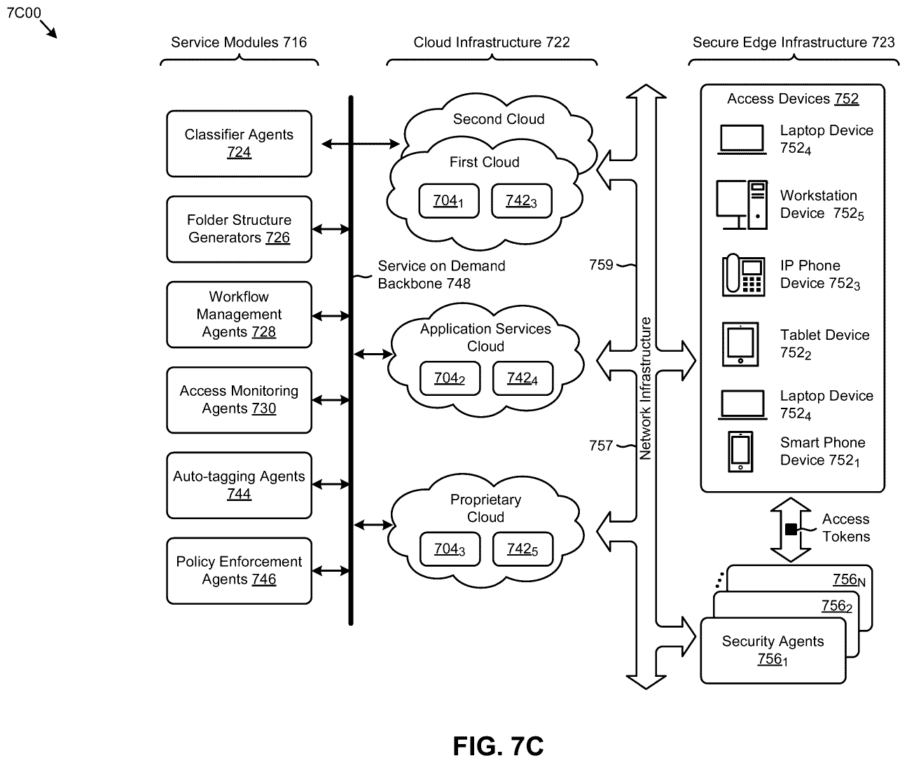

FIG. 7A depicts a block diagram of an instance of computer system 7A00 suitable for implementing embodiments of the present disclosure. Computer system 7A00 includes a bus 706 or other communication mechanism for communicating information. The bus interconnects subsystems and devices such as a central processing unit (CPU), or a multi-core CPU (e.g., data processor 707), a system memory (e.g., main memory 708, or an area of random access memory (RAM)), a non-volatile storage device or non-volatile storage area (e.g., read-only memory 709), an internal storage device 710 or external storage device 713 (e.g., magnetic or optical), a data interface 733, a communications interface 714 (e.g., PHY, MAC, Ethernet interface, modem, etc.). The aforementioned components are shown within processing element partition 701, however other partitions are possible. Computer system 7A00 further comprises a display 711 (e.g., CRT or LCD), various input devices 712 (e.g., keyboard, cursor control), and an external data repository 731.

According to an embodiment of the disclosure, computer system 7A00 performs specific operations by data processor 707 executing one or more sequences of one or more program instructions contained in a memory. Such instructions (e.g., program instructions 702₁, program instructions 702₂, program instructions 702₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 7A00 performs specific networking operations using one or more instances of communications interface 714. Instances of communications interface 714 may comprise one or more networking ports that are configurable (e.g., pertaining to speed, protocol, physical layer characteristics, media access characteristics, etc.) and any particular instance of communications interface 714 or port thereto can be configured differently from any other particular instance. Portions of a communication protocol can be carried out in whole or in part by any instance of communications interface 714, and data (e.g., packets, data structures, bit fields, etc.) can be positioned in storage locations within communications interface 714, or within system memory, and such data can be accessed (e.g., using random access addressing, or using direct memory access DMA, etc.) by devices such as data processor 707.

Communications link 715 can be configured to transmit (e.g., send, receive, signal, etc.) any types of communications packets (e.g., communication packet 738₁, communication packet 738_{N}) comprising any organization of data items. The data items can comprise a payload data area 737, a destination address 736 (e.g., a destination IP address), a source address 735 (e.g., a source IP address), and can include various encodings or formatting of bit fields to populate packet characteristics 734. In some cases, the packet characteristics include a version identifier, a packet or payload length, a traffic class, a flow label, etc. In some cases, payload data area 737 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 707 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 731, which in turn can be formatted into any one or more storage areas, and which can comprise parameterized storage 739 accessible by a key (e.g., filename, table name, block address, offset address, etc.).

Execution of the sequences of instructions to practice certain embodiments of the disclosure are performed by a single instance of computer system 7A00. According to certain embodiments of the disclosure, two or more instances of computer system 7A00 coupled by a communications link 715 (e.g., LAN, public switched telephone network, or wireless network) may perform the sequence of instructions required to practice embodiments of the disclosure using two or more instances of components of computer system 7A00.

Computer system 7A00 may transmit and receive messages such as data and/or instructions organized into a data structure (e.g., communications packets). The data structure can include program instructions (e.g., application code 703), communicated through communications link 715 and communications interface 714. Received program instructions may be executed by data processor 707 as it is received and/or stored in the shown storage device or in or upon any other non-volatile storage for later execution. Computer system 7A00 may communicate through a data interface 733 to a database 732 on an external data repository 731. Data items in a database can be accessed using a primary key (e.g., a relational database primary key).

Processing element partition 701 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 707. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to defining a security perimeter based on content management system observations of user behavior. A module may include one or more state machines and/or combinational logic used to implement or facilitate the operational and/or performance characteristics pertaining to/or isolating passages from context-laden collaboration system content objects.

Various implementations of database 732 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of isolating passages from context-laden collaboration system content objects). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to isolating passages from context-laden collaboration system content objects, and/or for improving the way data is manipulated when performing computerized operations pertaining to continuously updating content object-specific risk assessments.

FIG. 7B depicts a block diagram of an instance of cloud-based environment 7B00. Such a cloud-based environment supports access to workspaces through the execution of workspace access code (e.g., workspace access code 742₀, workspace access code 742₁, and workspace access code 742₂). Workspace access code can be executed on any of access devices 752 (e.g., laptop device 752₄, workstation device 752₅, IP phone device 752₃, tablet device 752₂, smart phone device 752₁, etc.), and can be configured to access any type of object. Strictly as examples, such objects can be folders or directories or can be files of any filetype. The files or folders or directories can be organized into any hierarchy. Any type of object can comprise or be associated with access permissions. The access permissions in turn may correspond to different actions to be taken over the object. Strictly as one example, a first permission (e.g., PREVIEW_ONLY) may be associated with a first action (e.g., preview), while a second permission (e.g., READ) may be associated with a second action (e.g., download), etc. Furthermore, permissions may be associated to or with any particular user or any particular group of users.

A group of users can form a collaborator group 758, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 751, including in a middleware setting. As shown, a portion of the workspace access code resides in and can be executed on one or more processing elements (e.g., processing element 705₁). The workspace access code can interface with storage devices such as networked storage 755. Storage of workspaces and/or any constituent files or objects, and/or any other code or scripts or data can be stored in any one or more storage partitions (e.g., storage partition 704₀). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 757). A stored workspace can be delivered to a particular user and/or shared with other particular users via a download (e.g., a download from a processing element to an access device over a download network path 759).

FIG. 7C depicts a block diagram of an instance of cloud-based computing system 7C00 suitable for implementing embodiments of the present disclosure. More particularly, the cloud-based computing system is suitable for implementing a cloud content management system, which cloud-based computing system is sometimes known as a cloud content manager (CCM).

The figure shows multiple variations of cloud implementations that embody or support a CCM. Specifically, public clouds (e.g., a first cloud and a second cloud) are intermixed with non-public clouds (e.g., the shown application services cloud and a proprietary cloud). Any and/or all of the clouds can support cloud-based storage (e.g., storage partition 704₁, storage partition 704₂, storage partition 704₃) as well as access device interface code (workspace code 742₃, workspace code 742₄, workspace code 742₅).

The clouds are interfaced to network infrastructure, which provides connectivity between any/all of the clouds and any/all of the access devices 752. More particularly, any constituents of the cloud infrastructure 722 can interface with any constituents of the secure edge infrastructure 723 (e.g., by communicating over the network infrastructure). The aforementioned access devices can communicate over the network infrastructure to access any forms of identity and access management tools (IAMs) which in turn can implement or interface to one or more security agents (e.g., security agents 756₁, security agents 756₂, . . . , security agents 756_{N}). Such security agents are configured to produce access tokens, which in turn provide authentication of users and/or authentication of corresponding user devices, as well as to provide access controls (e.g., allow or deny) corresponding to various types of requests by devices of the secure edge infrastructure.

As shown, the cloud infrastructure is also interfaced for access to service modules 716. The various service modules can be accessed over the shown service on demand backbone 748 using any known technique and for any purpose (e.g., for downloading and/or for application programming interfacing and/or for local or remote execution). The service modules can be partitioned in any manner. The partitioning shown (e.g., into modules labeled as classifier agents 724, folder structure generators 726, workflow management agents 728, access monitoring agents 730, auto-tagging agents 744, and policy enforcement agents 746) is presented merely for illustrative purposes and many other service modules can be made accessible to the cloud infrastructure. Some of the possible service modules are discussed hereunder.

Classifier agents serve to automatically classify (and find) files by defining and associating metadata fields with content objects, and then indexing the results of that classification. In some cases, a classifier agent processes one or more content objects for easy retrieval (e.g., via bookmarking).

Folder structure generators relieve users from having to concoct names and hierarchies for folder structures. Rather, names and hierarchies of folder structures are automatically generated based on the actual information in the content objects and/or based on sharing parameters and/or based on events.

Workflow management agents provide automation to deal with repeatable tasks and are configured to create workflow triggers that in turn invoke workflows at particularly-configured entry points. Triggers can be based on any content and/or based on any observable events. Strictly as examples, triggers can be based on events such as, content reviews, employee onboarding, contract approvals, and so on.

Access monitoring agents observe and keep track of use events such as file previews, user uploads and downloads, etc. In some embodiments, access monitoring agents are interfaced with presentation tools so as to present easy-to-understand visuals (e.g., computer-generated graphical depictions of observed user events).

Auto-tagging agents analyze combinations of content objects and events pertaining to those content objects such that the analyzed content objects can be automatically tagged with highly informative metadata and/or automatically stored in appropriate locations. In some embodiments, one or more auto-tagging agents operate in conjunction with folder structure generators so as to automatically analyze, tag and organize content (e.g., unstructured content). Generated metadata is loaded into a content object index to facilitate near instant retrieval of sought after content objects and/or their containing folders.

Policy enforcement agents run continuously (e.g., in the background) so as to aid in enforcing security and compliance policies. Certain policy enforcement agents are configured to deal with items such as content object retention schedules, achievement of time-oriented governance requirements, and establishment and maintenance of trust controls (e.g., smart access control exceptions). Further, certain policy enforcement agents apply machine learning techniques to deal with items such as dynamic threat detection.

The CCM, either by operation of individual constituents and/or as a whole, facilitates collaboration with third parties (e.g., agencies, vendors, external collaborators, etc.) while maintaining sensitive materials in one secure place. The CCM implements cradle-to-grave controls that result in automatic generation and high availability of high-quality content through any number of collaboration cycles (e.g., from draft to final to disposal, etc.) while constantly enforcing access and governance controls.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for identifying selected portions of a set of content objects for use in generating a large language model (LLM) prompt, the method comprising:
identifying a content management system (CMS) wherein collaboration activities occur over time and over content objects maintained in the CMS, and wherein the CMS maintains a historical record of occurrences of the collaborator activities over the content objects;
receiving a natural language query from a CMS collaborator; and
using CMS metadata to reduce a larger corpus of content objects to a smaller corpus of context passages.

2. The method of claim 1, wherein the smaller corpus is formed by:
in a first phase, identifying selected constituents from the larger corpus of content objects based on CMS metadata; and
in a second phase, identifying selected passages from the selected constituents.

3. The method of claim 2:
wherein the first phase comprises identifying a subset of the content objects selected from the larger corpus of content objects, wherein the identifying is based at least in part on (i) a first portion of a user profile corresponding to the CMS collaborator, or (ii) a first set of collaboration activities involving the CMS collaborator; and
wherein the second phase comprises identifying selected passages that are drawn from the subset of the content objects and wherein the selected passages are selected based at least in part on (i) a second portion of the user profile corresponding to the CMS collaborator, or (ii) a second set of collaboration activities involving the CMS collaborator.

4. The method of claim 3, wherein either the first portion of the user profile or the second portion of the user profile is a group designation.

5. The method of claim 4, wherein the group designation is determined in response to an upload event.

6. The method of claim 4, wherein either the first set of collaboration activities involving the CMS collaborator or the second set of collaboration activities involving the CMS collaborator is at least one of, a collaboration group modification action, or an upload event, or a preview event, or a workload access event.

7. The method of claim 3, wherein a size of the subset of the content objects is based at least in part on a number M that controls a top-M subset of content objects that are considered in the second phase.

8. The method of claim 3, wherein the selected passages drawn from the subset of the content objects are based at least in part on a number N that controls a top-N subset of chunks.

9. The method of claim 3, further comprising:
generating an LLM prompt based on the selected passages that are drawn from the subset of the content objects; and
providing the LLM prompt to the LLM.

10. The method of claim 9, further comprising:
receiving an LLM answer from the LLM; and
presenting the LLM answer on a user station.

11. A non-transitory computer readable medium having stored thereon a sequence of instructions which, when stored in memory and executed by one or more processors causes the one or more processors to perform a set of acts for identifying selected portions of a set of content objects for use in generating a large language model (LLM) prompt, the set of acts comprising:
identifying a content management system (CMS) wherein collaboration activities occur over time and over content objects maintained in the CMS, and wherein the CMS maintains a historical record of occurrences of the collaborator activities over the content objects;
receiving a natural language query from a CMS collaborator; and
using CMS metadata to reduce a larger corpus of content objects to a smaller corpus of context passages.

12. The non-transitory computer readable medium of claim 11, wherein the smaller corpus is formed by:
in a first phase, identifying selected constituents from the larger corpus of content objects based on CMS metadata; and
in a second phase, identifying selected passages from the selected constituents.

13. The non-transitory computer readable medium of claim 12:
wherein the first phase comprises identifying a subset of the content objects selected from the larger corpus of content objects, wherein the identifying is based at least in part on (i) a first portion of a user profile corresponding to the CMS collaborator, or (ii) a first set of collaboration activities involving the CMS collaborator; and
wherein the second phase comprises identifying selected passages that are drawn from the subset of the content objects and wherein the selected passages are selected based at least in part on (i) a second portion of the user profile corresponding to the CMS collaborator, or (ii) a second set of collaboration activities involving the CMS collaborator.

14. The non-transitory computer readable medium of claim 13, wherein either the first portion of the user profile or the second portion of the user profile is a group designation.

15. The non-transitory computer readable medium of claim 14, wherein the group designation is determined in response to an upload event.

16. The non-transitory computer readable medium of claim 14, wherein either the first set of collaboration activities involving the CMS collaborator or the second set of collaboration activities involving the CMS collaborator is at least one of, a collaboration group modification action, or an upload event, or a preview event, or a workload access event.

17. The non-transitory computer readable medium of claim 13, wherein a size of the subset of the content objects is based at least in part on a number M that controls a top-M subset of content objects that are considered in the second phase.

18. The non-transitory computer readable medium of claim 13, wherein the selected passages drawn from the subset of the content objects are based at least in part on a number N that controls a top-N subset of chunks.

19. A system for identifying selected portions of a set of content objects for use in generating a large language model (LLM) prompt, the system comprising:
a storage medium having stored thereon a sequence of instructions; and
one or more processors that execute the sequence of instructions to cause the one or more processors to perform a set of acts, the set of acts comprising,
identifying a content management system (CMS) wherein collaboration activities occur over time and over content objects maintained in the CMS, and wherein the CMS maintains a historical record of occurrences of the collaborator activities over the content objects;
receiving a natural language query from a CMS collaborator; and
using CMS metadata to reduce a larger corpus of content objects to a smaller corpus of context passages.

20. The system of claim 19, wherein the smaller corpus is formed by:
in a first phase, identifying selected constituents from the larger corpus of content objects based on CMS metadata; and
in a second phase, identifying selected passages from the selected constituents.
